(19) United States
(12) Patent Application Publication
(10) Pub. No.: US 2009/0060001 A1
(43) Pub. Date: Mar. 5, 2009

(54) COGNITIVE FREQUENCY HOPPING RADIO

(76) Inventor: Alan E. Waltho, San Jose, CA (US)

Correspondence Address: INTEL CORPORATION;c/o INTELLEVATE, LLC, P.O. BOX 52050, MINNEAPOLIS, MN, 55402, US

(21) Appl. No.: 11/845,736

(22) Filed: Aug. 27, 2007

(51) Int. Cl. H04B 1/713

(52) U.S. Cl. 375/133; 375/E01.033

(57) ABSTRACT

A cognitive frequency hopping radio includes a cognitive engine to actively monitor frequency spectrum to adapt transmission characteristics of the cognitive radio to communicate with other devices operating in the network. A frequency hopping block controls the transmitter to transmit radio signals by switching a carrier among many frequency channels using a pseudo-random sequence. The cognitive frequency hopping radio uses the short dwell times to essentially prevent harmful interference to incorrectly identify vacant channels.

Much of the radio frequency spectrum is inefficiently utilized, with some frequency bands being overloaded while some frequencies are under utilized. Access to this spectrum could alleviate the spectrum shortages. There is a need to allow licensed and unlicensed devices to operate on a non-interfering basis and allow real time access to the spectrum that is not in use by primary licensees at a given location and instant in time.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram that illustrates features of a Cognitive Frequency Hopping Radio (CFHR) in accordance with the present invention;

FIG. 2 is a diagram that illustrates the Cognitive Frequency Hopping Radio (CFHR) in communication with other mobile devices, a base station, and an access point;

FIG. 3 is a diagram that illustrates a sequence of events at the base station or the access point; and

FIG. 4 is a diagram that illustrates a sequence of events at a subscriber terminal.

It will be appreciated that for simplicity and clarity of illustration, elements illustrated in the figures have not necessarily been drawn to scale. For example, the dimensions of some of the elements may be exaggerated relative to other elements for clarity. Further, where considered appropriate, reference numerals have been repeated among the figures to indicate corresponding or analogous elements.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. The following detailed description is not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

In various places and at different times most of the radio frequency spectrum may be inefficiently utilized, leaving some frequency bands overloaded but also leaving some frequencies under utilized. Moreover, regulator agencies provide fixed spectrum allocation to prevent rarely used frequencies from being used by unlicensed users even when their transmissions would not interfere with the assigned service. A realization that unlicensed users may utilize licensed bands whenever interference may be avoided leads to a paradigm for wireless communication by a Cognitive Radio (CR). The cognitive radio actively monitors several factors in the radio environment such as the frequency spectrum and the network to adapt its transmission characteristics to communicate with other devices.

Therefore, to allow licensed and unlicensed devices to operate on a non-interfering basis on the same frequency, the cognitive radio incorporates techniques and methods to identify channels unused by the licensed services and to mitigate intended emissions by an unlicensed device that would cause interference on channels in use by a licensed service. As such, the cognitive radio may allow real time access to the estimated ninety percent of spectrum that is not in use by primary licensees at a given location and instant in time. Access to this spectrum could alleviate the spectrum shortages resulting from the current static spectrum assignment mechanisms.

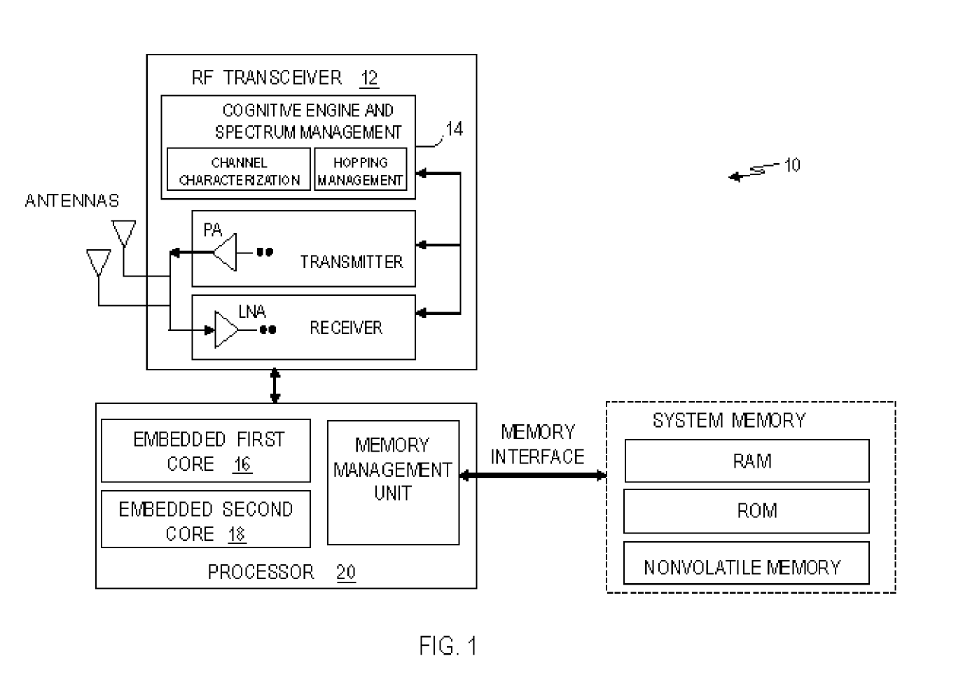

FIG. 1 illustrates features of a cognitive radio, but includes additional elements and features in accordance with the present invention for a Cognitive Frequency Hopping Radio (CFHR) 10. As shown in the figure, cognitive frequency hopping radio 10 is a radio that allows communication in an RF/location space and further includes a frequency hopping transceiver 12 with a cognitive engine and spectrum management block 14. With management block 14, CFHR 10 is capable of monitoring received signals in the communication channels to adapt to transmission characteristics, and further restrict the duration of transmissions on channels in use by licensed radios in accordance with the present invention. The frequency hopping transceiver transmits radio signals by switching a carrier among many frequency channels using a pseudo-random sequence known to both the transmitter and to a receiver.

The transceiver portion may be a stand-alone Radio Frequency (RF) discrete devices or an integrated analog circuit, or alternatively, be embedded with a processor 20 as a mixed-mode integrated circuit. The processor portion may include baseband and applications processing functions and utilize one or more processor cores. The use of multiple cores 16 and 18 may allow cores to be dedicated to handle application specific functions and further allow processing workloads to be shared across the cores. Processor 20 may transfer data through an interface to a system memory.

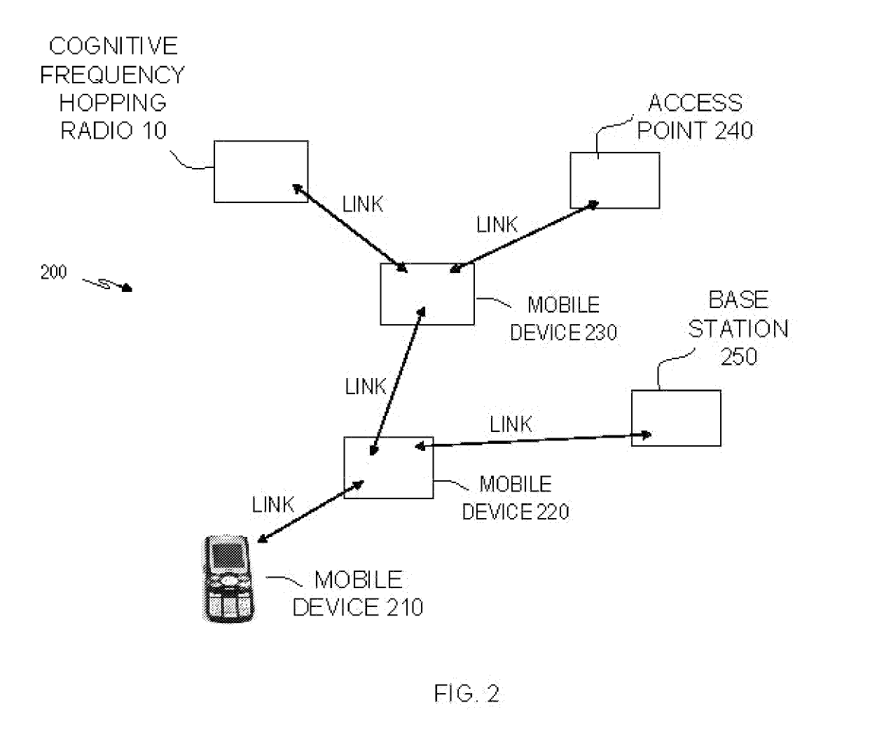

FIG. 2 shows a simplistic diagram that illustrates the operation of cognitive frequency hopping radio 10 in a wireless network 200 that includes mobile stations (STA) 210, 220, and 230, an access point (AP) 240, and a base station 250, although the number and the combination of electronic devices is not limiting to the claimed invention. Cognitive frequency hopping radio 10 may operate in a wireless network such as, for example, a Wireless Metropolitan Area Network (WMAN), a Wireless Personal Area Network (WPAN), or a combination thereof, and communicate in an RF/location space with other devices where interference may affect the quality of service of nearby radios. As shown, intermediate connections in a string of connections link two network devices so that most data packets are routed through several routers before reaching a final destination. Each time the data packet is forwarded to the next router, a hop occurs.

The devices in this network may operate in compliance with a wireless network standard, one example network being ANSI/IEEE Std. 802.11, 1999 Edition, although this standard is not a limitation of the present invention or a proprietary standard. In one embodiment, wireless network 200 may be a wireless Local Area Network (WLAN) that allows access point 240 and base station 250 to communicate with mobile stations 210, 220, and 230 either directly or through a shared medium. The shared medium may be a wireless channel in free space between the access point, the base station, and the various mobile stations. Also, mobile stations may communicate with other mobile stations using the wireless shared medium. Note that the mobile stations 210, 220, and 230 may be any type of mobile devices such as computers, personal digital assistants, wireless-capable cellular phones, home audio or video appliances that are capable of communicating in network 200.

In general, the concept for the cognitive radio is based on the detection of a set of vacant channels and using the most suitable vacant channel in accordance with spectrum policy rules and channel conditions. As previously mentioned, fundamental to cognitive radio operation is a requirement that there should not be harmful interference to the primary licensee. To satisfy this requirement the cognitive radio provides periodic spectrum monitoring, employs signal detection at levels well below the levels required for normal operation, and engages in handshaking in order to vacate the channel when used by the primary licensee. Without employing frequency hopping, a cognitive radio would need the sensitive detector as an important component in detecting transmissions by primary users under fading conditions and detecting hidden nodes. However, under normal conditions the sensitive detector may also detect primary users well beyond the cognitive radio's interference range, thus precluding access to otherwise usable spectrum.

To solve the problem of prior art cognitive radios needing a sensitive detector, the present invention for the Cognitive Frequency Hopping Radio (CFHR) includes frequency hopping to avoid harmful interference to primary users. Frequency hopping is achieved in the frequency band by dividing the RF band into multiple operating channels and hopping through the channels one at a time, in a pseudo-random pattern. Again, whereas the non-hopping Cognitive Radios (CRs) require a very sensitive detector to ensure detection of primary signals in an adverse propagation environment, the frequency hopping employed by CFHR 10 reduces the sensitivity needed for the detector.

This less stringent sensitivity requirement of CFHR 10 also improves spectrum access since primary users beyond the CFHR's interference range have a low probability of false detection. Furthermore, multiple orthogonal networks of CFHRs 10 may operate simultaneously on a non-interfering basis without the need to detect and avoid each other. CFHR 10 makes use of clock synchronized pseudo-random frequency hopping, monitoring each channel in the sequence and then transmitting only on those channels that are determined to have a low probability of being occupied.

In frequency hopping, the transmitter broadcasts on one frequency for a small amount of time before switching to another frequency using a known switching algorithm called a hopping code or hopping pattern. One challenge of frequency-hopping systems is to synchronize the transmitter and receiver. All radios may use the same pseudo-random sequence, so the receiver knows the same hopping code and is able to slide the code past the incoming signal until it synchronizes with the sender. Once synchronized, the transmitter and receiver follow the hopping code to switch frequencies and communicate. The resulting transmission is spread over a large frequency range and therefore appears as noise spikes to other receivers unless they know (or can decipher) the hopping code.

It should be pointed out that individual groups in a common net may be assigned different frequency sets and/or start times. Since the start times are recorded relative to the synchronized clock, the order of the known frequencies may be determined by simply sorting based on start time. After sorting the frequencies, the receiver may initiate the hopping code based on the synchronized clock, the derived order of the frequencies, and the measured dwell time for each frequency. Thus, multiple orthogonal networks may operate simultaneously on a non-interfering basis without the need to detect each other. Fast hopping with short dwell times may minimize the effect of interference on any of the primary channels that may incorrectly be identified as a vacant channel. Semi-cooperative sensing by the CFHRs may be employed for the users forming a common communications net.

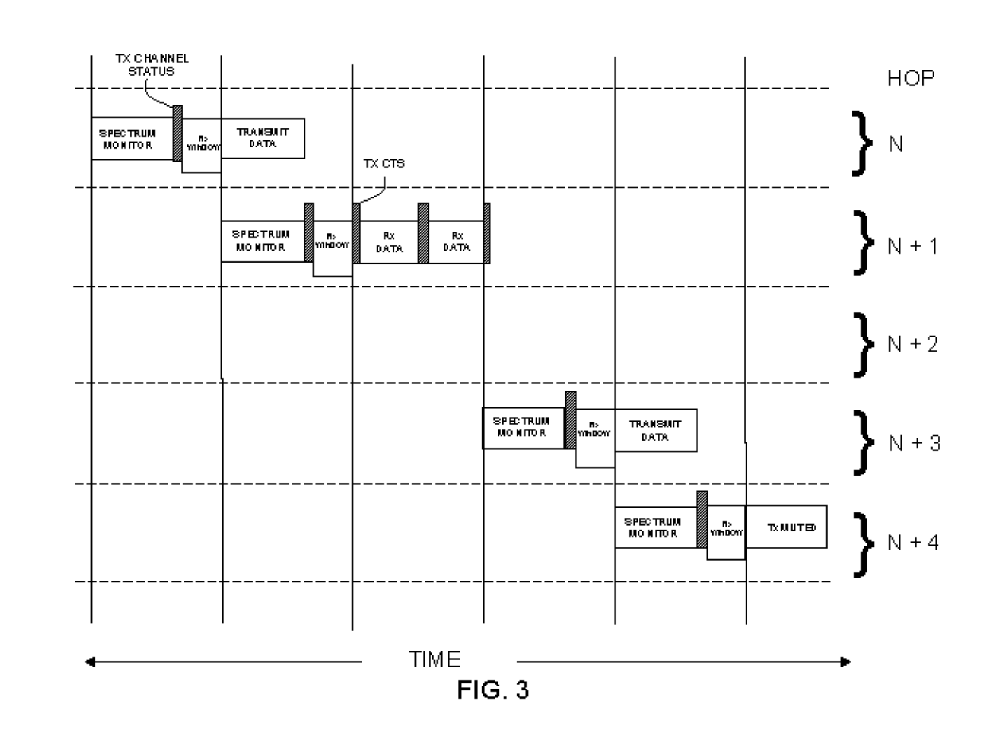

FIG. 3 is a diagram that illustrates a sequence of events at the base station or the access point. Upon the spectrum monitor detecting a vacant channel, a net master such as the base station or access point may transmit a short coded message in the form of a Gold or other binary coded Phase-Shift Keying (PSK) burst that conveys data by modulating the phase of the carrier. The coded message indicates the channel as being vacant and that the base station has a message to transmit, or alternatively, that the vacant channel is available for subscribers to transmit. Upon receiving the data burst, any other subscriber that also identifies the channel as vacant may transmit a short Acknowledgement frame (ACK) or Request-To-Send (RTS) if it has a message to transmit. Following the receipt of an ACK frame, the master can then transmit a data burst. Also, upon receipt of an RTS control packet the master replies by issuing a Clear-To-Send (CTS) control packet to the subscriber. After receiving the CTS, the subscriber then sends data and the subsequent data transmission occupies the remainder of the dwell time for that particular channel.

If the subscriber detects that the channel is occupied it can send a channel busy message. In the latter case the base station or the access point is able to avoid use of this channel for a period of time depending on the primary service assigned to the channel. By this means, all radios in the net detect a coded message that indicates a vacant channel, and thus, the “Hidden Node” problem may be significantly reduced.

There is a tradeoff between non-coherent detection modes and coherent detection modes considering that data bursts on each channel are likely to be short. Non-coherent detection modes result in lower data rates but also provide minimal signal acquisition time. The primary services allocated to each frequency dictate a burst time that may vary from a few microseconds for packet switched data services to a few hundred milliseconds for circuit switched voice services. Thus, the trade off for the non-coherent detection modes and the coherent detection modes takes the permissible burst length of the data packet into consideration.

Through the use of a second receiver the base station or access point operates in a dual channel mode for purposes of channel monitoring and traffic handling. While transmitting or receiving on a vacant channel the associated base station or access point the second receiver also monitors the next channel in the frequency hopping sequence. To avoid blocking by its own transmitter, a pseudo-random hopping pattern may be selected to ensure a wide frequency separation in the receiver spectrum monitor and the transmit channels. Because of the short dwell time, the spectrum monitor needs to quickly detect an occupied channel and may use, for example, simple energy detection to achieve that detection since any failure to detect a primary user would result in short term interference. Mobile devices do not provide a dual channel capability, and therefore, spectrum monitoring may not take place when there is traffic either to or from a specific mobile device. Other mobile devices in the net not transmitting or receiving traffic would advance to the next frequency and monitor that channel.

Depending on the characteristics of the transmitter and receiver, frequency hopping transmitters and receivers may operate over a bandwidth of one octave such as, for example, 1 GHz to 2 GHz, or 2 GHz to 4 GHz. Ideally, the channel bandwidth of CFHR 10 should substantially match, or be no greater than, the bandwidth of the primary users applicable to the specific frequency. By placing limits on the bandwidth, the probability of overlapping with two or more primary users at each frequency hop is reduced. In the 2 GHz to 4 GHz popular frequency band, the primary user bandwidth may be 5 MHz or more. This primary user bandwidth allows four hundred channels for frequency hopping, where each channel has 5 MHz. Assuming simultaneous monitor and transmitting on the channels on adjacent frequency hops and an effective dwell time for each channel of one millisecond, the overall cycle time would be 0.4 seconds.

FCC published data indicates that channel utilization varies between 0.25 and 7.6% in the frequency band 2 GHz to 4 GHz. For this frequency band and assuming an average value of 4%, a device with the capabilities of CFHR 10 may expect to find 96% of channels unoccupied by primary licensees. Since frequency hopping sets for different groups of communicators are orthogonal, collisions with other CFHR devices would not occur and overall spectrum access for CFHR 10 would approach 96%. With reasonable buffering such as two hops, for example, transmission and reception of high Quality of Service (QoS) communications may be achieved.

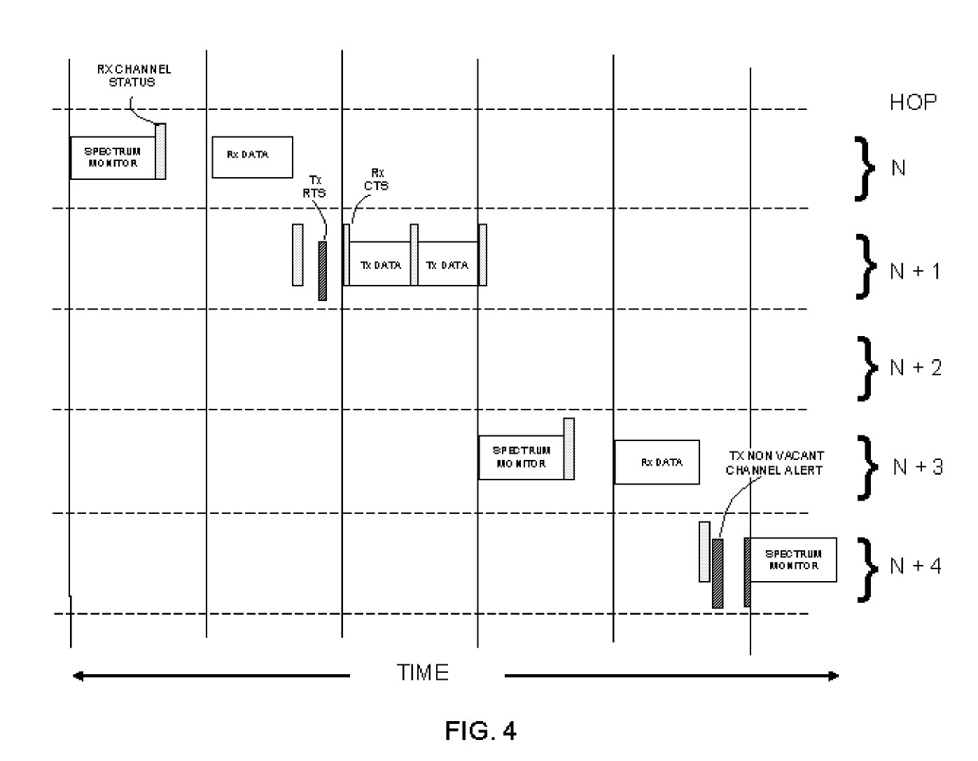

FIG. 4 is a diagram that illustrates a sequence of events at a subscriber terminal. Handshaking between a base station and subscriber consists of a short burst Channel Status (CS) from the base station to indicate channel vacancy, a widow for receipt of channel status or Request to Send (RTS) messages from subscribers followed by a Clear to Send (CTS) to a specific subscriber. The receive window must be large enough to allow randomly timed contention access messages from multiple subscribers. For planning purposes a window of five times the burst length is assumed. Assuming Binary coded sequences of length 23 bits are used for the handshaking, then at 3.84 Mbps the total handshaking transaction would be of duration 42 microseconds [(23+(5*23)+23)/3840000]. A possible payload throughput for simple binary modulation would then be 3.53 Mbps. Higher throughputs are obviously possible using more complex modulation schemes.

By now it should be apparent that embodiments of the present invention provide for a cognitive frequency hopping radio. Features of the cognitive frequency hopping radio use the short dwell time to essentially prevent harmful interference to incorrectly identify vacant channels. Additionally, sensitive primary signal detection is not necessary for the cognitive frequency hopping radio and complex rules for channel utilization are not required. Therefore, the less stringent sensitivity requirements improve spectrum usage since primary users beyond the interference range have a reduced probability of false detection that otherwise would restrict the use of the channel by a non-hopping cognitive radio. Furthermore, handshaking overheads are reduced as the next frequency is determined by the predetermined sequence.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A radio to operate in a network, comprising:
a cognitive engine to actively monitor frequency spectrum to adapt transmission characteristics of the radio to communicate with another device operating in the network; and
a frequency hopping block to transmit radio signals by switching a carrier among many frequency channels using a pseudo-random sequence.

2. The radio of claim 1 wherein the cognitive engine and the frequency hopping block facilitate broadband connectivity that is capable of operating on a non-interfering basis regardless of local spectrum allocations and restrictions.

3. The radio of claim 1 wherein the pseudo-random sequence is known to a transmitter in the radio and to a receiver of the another device.

4. The radio of claim 1 wherein the frequency hopping block of a base station or an access point uses clock synchronized pseudo-random frequency hopping.

5. The radio of claim 4 wherein the frequency hopping block of a subscriber radio uses pseudo-random frequency hopping synchronized to the base station or the access point.

6. The radio of claim 1 wherein the cognitive engine monitors channels and transmits on a channel selected to have a low probability of being occupied and the frequency hopping block allow the radio

7. The radio of claim 1 wherein the radio and the another device in a first common net communicate in the network using a same pseudo-random sequence but a different frequency set from devices in a second common net.

8. The radio of claim 7 wherein the radio and the another device in the first common net communicate in the network using the same pseudo-random sequence but different start times from the devices in the second common net.

9. The radio of claim 1 wherein the radio and the another device use multiple orthogonal networks to operate simultaneously on a non-interfering basis without needing to detect each other.

10. A cognitive frequency hopping radio, comprising:
an antenna;
a transceiver;
a cognitive engine to monitor channel data received by the antenna and adapt transmission characteristics of the transceiver to transmit data from the antenna; and
a hopping management block to control the transceiver to switch a carrier frequency among many frequency channels using a pseudo-random sequence.

11. The cognitive frequency hopping radio of claim 10 wherein the cognitive frequency hopping radio uses a short dwell time to prevent harmful interference to incorrectly identify vacant channels.

12. The cognitive frequency hopping radio of claim 10 wherein the hopping management block uses a next frequency as determined by a predetermined sequence to change channels and reduce handshaking overhead associated with channel management.

13. A cognitive frequency hopping radio, comprising:
an antenna;
a transceiver having a transmitter and a receiver coupled to the antenna;
a cognitive engine to identify channels unused by licensed services and to monitor received data to adapt channel transmission characteristics to dynamically configure the transmitter for communication in a network; and
a frequency hopping block to control multiple operating channels and hop through channels one at a time in a pseudo-random pattern.

14. The cognitive frequency hopping radio of claim 13 wherein the radio uses frequency hopping to avoid harmful interference to primary users.

15. The cognitive frequency hopping radio of claim 13 wherein the cognitive engine and the frequency hopping block facilitate broadband connectivity that operates on a non-interfering basis regardless of spectrum allocations.

16. The cognitive frequency hopping radio of claim 13 wherein the pseudo-random sequence is known to the transmitter in the radio and to a receiver of another device.

17. The cognitive frequency hopping radio of claim 13 wherein the radio is included in an access point.

18. The cognitive frequency hopping radio of claim 13 wherein the radio is included in a mobile device.

19. The cognitive frequency hopping radio of claim 13 wherein the radio is included in a base station.

20. The cognitive frequency hopping radio of claim 13 further including a second receiver at access points and base stations to monitor a first channel while simultaneously transmitting or receiving traffic on a second channel.

21. A method for operating a radio in a network, comprising:
actively monitoring frequency spectrum using a cognitive engine to adapt transmission characteristics of the radio to communicate with another device operating in the network; and
switching a carrier among many frequency channels using a pseudo-random sequence to transmit radio signals.

22. The method of claim 21 further including selecting a pseudo-random hopping pattern to ensure a wide frequency separation in a receiver spectrum monitor and traffic transmit or receive channels.

23. The method of claim 22 further including monitoring of the traffic transmit or receive channels by subscriber members of the network and communicating a channel busy status to a base station or an access point.
